(19) United States
(12) Patent Application Publication
(10) Pub. No.: US 2025/0168925 A1
(43) Pub. Date: May 22, 2025

(54) A SYSTEM AND METHOD OF CAPABILITY NEGOTIATION BETWEEN A UE AND NETWORK FOR MULTICAST SERVICE DELIVERY

(71) Applicant: SAMSUNG ELECTRONICS CO., LTD., Suwon-si, Gyeonggi-do (KR)

(72) Inventors: Varini GUPTA, Bangalore (IN); Vinay Kumar SHRIVASTAVA, Bangalore (IN); Sriganesh RAJENDRAN, Bangalore (IN)

(21) Appl. No.: 18/729,146

(22) PCT Filed: Jan. 13, 2023
(86) PCT No.: PCT/KR2023/000674

§ 371 Date: Jul. 15, 2024

(30) Foreign Application Priority Data
Jan. 13, 2022 (IN) 202241001909
Jan. 9, 2023 (IN) 202241001909

(51) Int. Cl. H04W 76/40; H04W 4/06; H04W 8/24; H04W 76/27

(52) U.S. Cl. CPC H04W 76/40; H04W 4/06; H04W 8/24; H04W 76/27

(57) ABSTRACT

The present disclosure relates to a system and method of providing UE capability of supporting reception of multicast in Radio Resource Control_INACTIVE (RRC_INACTIVE) state. The method comprises sending an uplink-message to a communication network to register the UE's intention of joining a multicast session to receive a multicast service. Further a capability-indication is included in the uplink-message, where the capability indication indicates if the UE is capable of joining the multicast session in Radio Resource Control_INACTIVE (RRC_INACTIVE) state. Furthermore, the multicast service is received in the RRC_INACTIVE state based on capability negotiation between the UE and the communication network, in response to the capability indication.

### TECHNICAL FIELD

The present invention relates generally to the field of 5G multicast and broadcast services, and more particularly, to a system and method of capability negotiation between a User Equipment (UE) and a network for multicast service delivery in RRC_INACTIVE state.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Use case of multicast service may include public safety services, mission critical services, commercial services and/or dense deployment scenarios e.g., stadium, concert. When a very large number of users simultaneously connect to network to receive a multicast service, they may exceed the normal admission control limits of the cell, and thus may be unable to receive the multicast service.

Thus, it is desired to address one or more of the above-mentioned disadvantages or other shortcomings and at least provide a useful alternative.

### Solution to Problem

In an embodiment, the present disclosure relates to a method for assisting capability negotiation between a User Equipment (UE) and a communication network for multicast service delivery to the UE. The method is performed by the UE. The method comprises sending an uplink-message to a communication network to register the UE's intention of joining a multicast session to receive a multicast service. The method further comprises including, a capability-indication in the uplink-message, where the capability indication indicates if the UE is capable of joining the multicast session in Radio Resource Control_INACTIVE (RRC_INACTIVE) state. The method further comprises receiving the multicast service in the RRC_INACTIVE state based on capability negotiation between the UE and the communication network, in response to sending the capability indication.

The present disclosure relates to a method for assisting capability negotiation between a User Equipment (UE) and a communication network for multicast service delivery to the UE. The method is performed by the communication network. The method comprises receiving an uplink message from a UE to register the UE's intention of joining a multicast session. Further, the method comprises receiving a capability-indication in the uplink-message where the capability-indication indicates if the UE is capable of joining the multicast session in Radio Resource Control_Inactive (RRC_INACTIVE) state. Furthermore, the method comprises determining one or more parameters related to the UE and the communication network. Thereafter, sending a multicast service to the UE in the RRC_INACTIVE state based on capability negotiation between the UE and the communication network, based on the capability indication.

The foregoing summary is illustrative only and is not intended to be in any way limiting. In addition to the illustrative aspects, embodiments, and features described above, further aspects, embodiments, and features will become apparent by reference to the drawings and the following detailed description.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### Advantageous Effects of Invention

The disclosure relates to a 5G or 6G communication system for supporting a higher data transmission rate.

### BRIEF DESCRIPTION OF DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference features and components. Some embodiments of system and/or methods in accordance with embodiments of the present subject matter are now described, by way of example only, and regarding the accompanying figures, in which:

FIG. 1 illustrates an exemplary message flow between UE and communication network for capability negotiation for offering multicast services in RRC_INACTIVE mode, according to embodiments enclosed herein;

FIG. 2 illustrates an exemplary message flow between the UE and the network for capability negotiation via 5GSM capability exchange, in some embodiments of the present disclosure;

FIG. 3 illustrates an exemplary message flow between the UE and the communication network for capability negotiation via 5GMM capability exchange, in accordance with some embodiments of the present disclosure.

FIG. 4 illustrates the signalling of UE's support to receive Multicast Broadcast Service (MBS) in RRC_INACTIVE state and also other UE capability parameters at Access Stratum level message exchange between UE and NG-RAN; and

FIG. 5 illustrates a block diagram of an exemplary UE, for negotiating capability information with a communication network, in accordance with some embodiments of the present disclosure.

FIG. 6 depicts a flow diagram of an exemplary method for assisting capability negotiation between a User Equipment (UE) and a communication network for multicast service delivery to the UE.

FIG. 7 depicts a flow diagram of an exemplary method for assisting negotiation between a communication network and a User Equipment (UE) for multicast service delivery by the communication network.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### MODE FOR THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises” a″ does not, without more constraints, preclude the existence of other elements or additional elements in the device or system or apparatus.

The terms “includes”, “including”, or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet and/or the like) that includes data. It will be appreciated that numerous other arrangements are possible.

As used herein, the term “user equipment” may refer to any electronic device that may be transported and operated by a user, which may also provide remote communication capabilities to a network and supports cellular communication. Examples of remote communication capabilities include using a mobile phone (wireless) network, wireless data network (e.g., 5G or similar networks), or any other communication medium that may provide access to a communication network. Examples of user equipment includes mobile phones (e.g., cellular phones), PDAs, tablet computers, net books, laptop computers, personal computers etc. A mobile device may comprise any suitable hardware and software for performing such functions and may also include multiple devices or components (e.g., when a device has remote access to a network by tethering to another device—i.e., using the other device as a relay-both devices taken together may be considered a single mobile device).

As used herein, the term “processor” may refer to any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

As used herein, the term “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to a method for assisting negotiation between a User Equipment (UE) and a communication network for multicast service delivery to the UE. Currently, there exists no method or system that assists the negotiation between the UE and the communication network for the feature of “multicast service delivery in Radio Resource Control_INACTIVE (RRC_INACTIVE) state” in release 18 of 3GPP. To address the issue at hand, the present disclosure discloses a method that aids the negotiation, between the UE and communication network, of whether the UE and/or the communication network is capable of receiving or sending the multicast service in RRC_INACTIVE state. The method comprises sending an uplink-message to a communication network to register the UE's intention of joining a multicast session to receive a multicast service. The method comprises including a capability-indication in the uplink-message, where the capability indication indicates if the UE is capable of and/or intends to joining the multicast session in the RRC_INACTIVE state. The method further comprises receiving the multicast service in the RRC_INACTIVE state based on capability negotiation between the UE and the communication network, in response to the capability indication.

In an embodiment, the communication network comprises of at least one of a Next-Generation Radio Access Network (NG-RAN), an Access and Mobility Function (AMF) and a Session Management Function (SMF) and where the uplink-message and/or the capability-indication is sent to one of the NG-RAN, the AMF or the SMF. In one embodiment, the NG-RAN, the SMF and the AMF may be embodied as software functions in a computing environment. In another embodiment, the NG-RAN, the SMF and the AMF may be hardware components. In an embodiment, the SMF and the AMF form a core network of the communication network.

In an embodiment, the UE may receive a network-capability-message from the communication network, informing the UE if the communication network supports or intends to offer multicast service in RRC_INACTIVE. The UE also receives a bearer-message from the communication network, informing the UE about multicast radio bearer on which the multicast service will be delivered. In an embodiment, the network-capability-message and the bearer-message may be included in at least one of an RRC configuration message received by the UE from the communication network, a System Information Block (SIB) message, a Multicast Control Channel (MCCH) message, an RRC reconfiguration message and an RRC release message received by the UE from the communication network.

In an embodiment, the capability-indication may be sent to the SMF as part of a Protocol Data Unit (PDU) session modification request or a PDU session establishment request or a new or existing Non Access Stratum (NAS) message and is contained inside a 5GSM capability Information Element (IE).

In an embodiment, the capability-indication is sent to the AMF as part of a registration request message or a new or existing NAS message and contained inside a 5GMM capability Information Element (IE).

In an embodiment, the capability indication may be sent to the NG-RAN as part of RRC message.

The UE capability indication includes configuration settings which indicates whether the UE is capable of receiving the multicast service in the RRC_INACTIVE state. In an embodiment, the configuration settings may include a field to indicate to the network that the UE is capable of receiving the multicast service in the RRC_INACTIVE state.

In an embodiment, the capability-indication may be a part of a 5G system Global Session Management (5GSM) capability Information Element (IE) and/or an RRC message. The RRC message is one of UE capability information message, UE assistance information message, MBS interest indication message, RRC Connection Request, RRC Setup Request, RRC Setup Complete, RRC Reconfiguration Complete, RRC Reestablishment Request, RRC Reestablishment Complete, RRC Resume Request, RRC Resume Complete messages.

In an embodiment, the capability negotiation between the UE and the communication network is based on one or more parameters. The one or more parameters comprises at least one of UE's capability-indication, network congestion, and network capability. The multicast service is received in RRC_INACTIVE state by the UE, based on the UE's capability and/or intention to receive the multicast service in the RRC_INACTIVE state, the network's capability and/or intention to deliver the multicast service in the RRC_INACTIVE state, network congestion. For e.g. if the communication network is congested, and if there are UE's that are capable and UEs not capable of receiving the multicast service in RRC_INACTIVE state, then in that case, the communication network may push the multicast service in the RRC_INACTIVE state to the UEs that are capable of receiving the multicast service in the RRC_INACTIVE state in order to free up the communication network resources.

In an embodiment, receiving the multicast service comprises receiving an indication of network capability for providing multicast service in RRC_INACTIVE state and/or configuration for the multicast service reception in RRC_INACTIVE state prior to communication in one of a paging message, broadcast signalling message like SIB or a MCCH.

The present disclosure relates to a method for assisting negotiation between the communication network and the UE for multicast service delivery by the communication network. The method comprises receiving an uplink message from the UE to register the UE's intention of joining a multicast session. The method comprises receiving a capability-indication in the uplink-message, where the capability-indication indicates if the UE is capable of joining the multicast session in Radio Resource Control_Inactive (RRC_INACTIVE) state. The method further comprises determining, one or more parameters related to the UE and the communication network and sending a multicast service to the UE in the RRC_INACTIVE state based capability negotiation between the UE and the communication network, in response to the capability indication.

In an embodiment, the communication network comprises at least one of a Next-Generation Radio Access Network (NG-RAN), Access and Mobility Function (AMF) and Session Management Function (SMF). The uplink-message and/or the capability-indication are received by one of the NG-RAN, the AMF or the SMF.

In an embodiment, the communication network may send a network-capability-message to the UE, informing the UE if it supports multicast service in RRC_INACTIVE. The communication network also sends a bearer-message to the communication network, informing the UE about multicast radio bearer on which the multicast service would be delivered. The network-capability-message and the bearer-message may be included in an System Information Block (SIB) message, a Multicast Control Channel (MCCH) message, an RRC reconfiguration message or an RRC release message sent by the communication network to the UE.

In an embodiment, the capability-indication may be received by the SMF as part of a Protocol Data Unit (PDU) session modification request or a PDU session establishment request or a new or existing Non Access Stratum (NAS) message and is contained inside a 5GSM capability Information Element (IE). The capability-indication may be sent by the SMF to the NG-RAN in an N2-Session Management (N2-SM) message or to the AMF by using new or existing Service Based Interface-Application Program Interfaces (SBI APIs) exposed by AMF or SMF in a new or existing IE. The capability-indication is sent by the AMF to NG-RAN using a new or existing NG-Application Protocol (NG-AP) IE in the NG-AP message.

In an embodiment, the capability-indication may be received by the AMF as part of a registration request message or a new or existing NAS message and contained inside a 5GMM capability Information Element (IE). The capability-indication is sent by the AMF to the NG-RAN using a new or existing NG-AP IE as part of the NG-AP message and/or to the SMF in an Nsmf_PDUSession_UpdateSMContext message. The capability-indication is sent by the SMF to the NG-RAN in an N2-SM message.

In an embodiment, the capability-indication may be received by the NG-RAN as part of RRC message. The capability-indication is further sent to at least one of the AMF and the SMF.

In an embodiment, the capability-indication may be a part of at least one of a 5G system Session Management (5GSM) capability Information Element (IE) or an RRC message. The RRC message is one of UE capability information message, UE assistance information message, MBS interest indication message, RRC Connection Request, RRC Setup Request, RRC Setup Complete, RRC Reconfiguration Complete, RRC Reestablishment Request, RRC Reestablishment Complete, RRC Resume Request, RRC Resume Complete messages.

In an embodiment, the IE may be stored by the SMF in a UE-context, and the IE can be further sent to at least one of: the NG-RAN, when the SMF provides the NG-RAN with MBS-Session information and associated PDU-session information corresponding to the UE, as part of N2-Session Management (N2-SM) information, or the AMF, as part of a Nsmf_PDUSession_UpdateSMContext response message, when the SMF responds to the uplink message sent by the UE, which is then provided to the NG-RAN as an NG Application Protocol (NG-AP) IE.

In an embodiment, the uplink-message and capability-indication is included as part of 5GMM capability IE during registration procedure. And the IE is stored and sent to one of: the AMF in the UE-context and is further sent to the NG-RAN as part of an existing or a new NG-AP IE or as part of a UE_Context_Modification_Messsage or the SMF as part of Nsmf_PDUSession_UpdateSMContext request message, when the AMF sends the join request to the SMF, the SMF provides the IE to the NG-RAN as part of N2-SM information.

In an embodiment, the IE is stored by the NG-RAN in the UE-context and is further sent to at least one of the AMF and the SMF for storing as part of their UE-Context data.

In an embodiment, the capability negotiation between the communication network and the UE is based on one or more parameters. The one or more parameters comprises at least one of UE's capability-indication, network congestion, and network capability. The multicast service is sent in RRC_INACTIVE state to the UE, based on the UE's capability to receive the multicast service in the RRC_INACTIVE state, the network's capability to deliver the multicast service in the RRC_INACTIVE state, network congestion. For e.g., if the communication network is too congested, and if there are both UE's capable and not capable of receiving the multicast service in RRC_INACTIVE state, then in that case, the communication network will push the UE's that are capable to the RRC_INACTIVE state in order to free up the communication network.

In an embodiment, sending the multicast service comprises sending a result of capability negotiation when the session is activated and communicated in one of a paging message, broadcast signalling message like SIB or a MCCH.

In an embodiment, receiving the multicast service comprises receiving an indication of network capability for providing multicast service in RRC_INACTIVE state and/or configuration for the multicast service reception in RRC_INACTIVE state prior to communication in one of a paging message, broadcast signalling message like SIB or a MCCH.

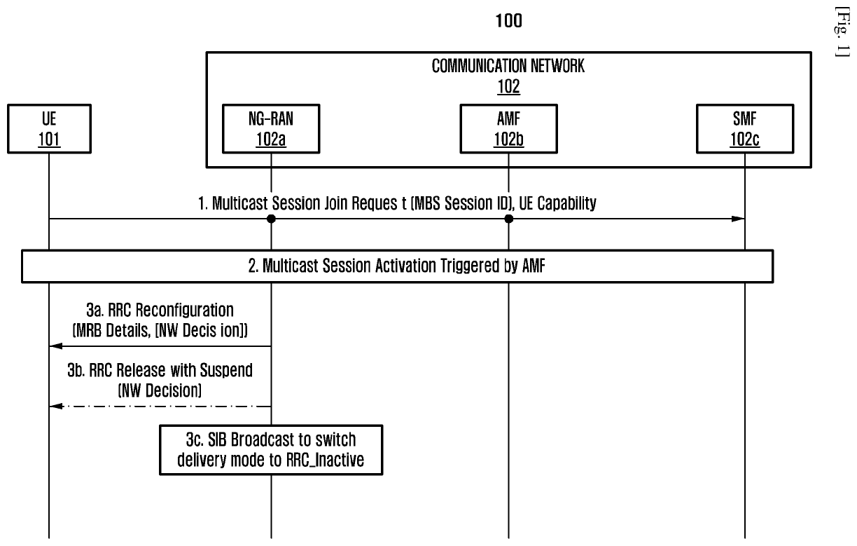

FIG. 1 is an exemplary flow of events leading to capability negotiation between (UE) 101 and communication network 102 offering multicast services in Radio Resource Control_INACTIVE (RRC_INAVTIVE) mode, according to embodiments enclosed herein. The communication network 102 further comprises of Next-Generation Radio Access Network (NG-RAN) 102a, Access and Mobility Function (AMF) 102b and Session Management Function (SMF) 102c.

At Step #1, the UE 101 sends an uplink-message to the communication network 102 to register its intention of joining a multicast session identified by an MBS Session ID. This uplink-message may also contain the UE's capability to join the multicast session in the RRC_INCATIVE state.

At Step #2, the multicast session activation procedure is initiated.

At Step #3a, NG-RAN 102a sends the RRC Reconfiguration message to the UE 101 to inform about the Multicast Radio Bearer (MRB) information on which multicast service will be delivered. The UE 101 is now configured to receive multicast service.

At Step #3b, NG-RAN 102a may send RRC Release with Suspend configuration to the UE 101 to move it to Radio Resource Control_INACTIVE (RRC_INACTIVE) state. This could be triggered by, e.g. congestion at network, and/or UE 101 not utilizing non-multicast services. Additionally, RRC Release with Suspend configuration may also include the indication for multicast service(s) reception in RRC_INACTIVE state and/or associated configurations for multicast service(s) reception in RRC_INACTIVE state.

At Step #3c, NG-RAN 102a broadcasts as part of System Information (SIB) and or Multicast Control CHannels (MCCH), if a particular multicast service identified by TMGI, is available for reception in RRC_INACTIVE state and/or associated configurations for multicast service(s) reception in RRC_INACTIVE state. The UEs which had been configured with the details of multicast resource blocks (in Step #3a), and have since moved to RRC_INACTIVE state, can start receiving the multicast service based on this indication.

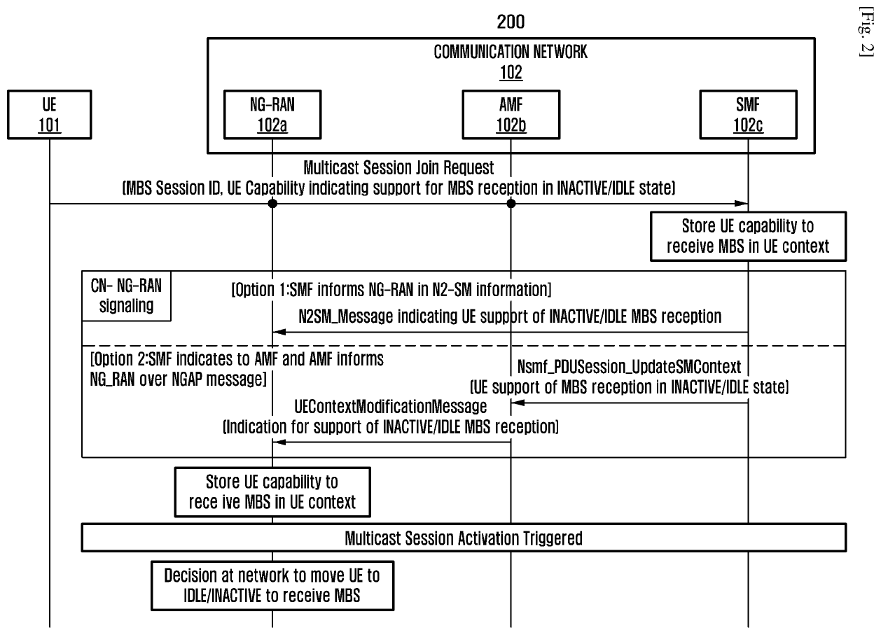

FIG. 2 is an example flow of events depicting UE capability negotiation between UE 101 and communication network 102 via 5GSM capability exchange. The figure also depicts signalling between Core Network and Next-Generation Radio Access Network (NG-RAN) 102a node. The communication network 102 comprises of NG-RAN 102a, Access and Mobility Function (AMF) 102b and Session Management Function (SMF) 102c.

In an embodiment, the UE 101 sends an uplink-message to the communication network 102 to register its intention of joining a multicast session identified by an MBS Session ID. This uplink-message may also contain the UE's 101 capability to join the multicast session in the RRC_INCATIVE state.

In an embodiment, the UE 101 may include an indication as part of 5GSM capability Information Element (IE), indicating whether it supports receiving multicast service in Radio Resource Control_INACTIVE (RRC_INACTIVE) state. The IE is stored by SMF 102c in the UE-context and is further sent to NG-RAN 102a when SMF 102c provides the NG-RAN 102a with Multicast Broadcast Service-Session information (MBS-Session information) and associated Protocol Data Unit Session Information (PDU-Session Information) corresponding to the UE 101, as part of N2-SM information i.e., as part of N2SM_Message.

In an Embodiment, the IE may be sent to AMF 102b as part of Nsmf_PDUSession_UpdateSMContext response message, when SMF 102c responds to the join request, which is then provided to the NG-RAN 102a as an NG-AP IE or as part of the UE_Context_Modification_Message.

The UE's 101 capability is stored at the NG-RAN 102a. The multicast session activation may be triggered and at this point of time, UE 101 can start receiving multicast service. The NG-RAN 102a may send RRC Release with Suspend configuration to the UE 101 to move it to RRC_INACTIVE state. This could be triggered by, e.g., congestion at network, and/or UE 101 not utilizing non-multicast services.

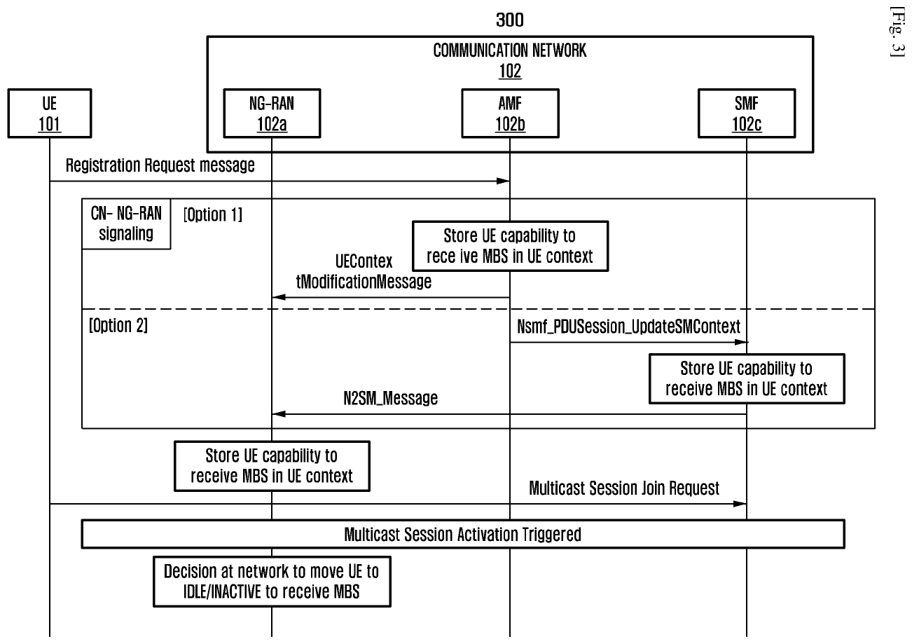

FIG. 3 is an example flow of events depicting the UE capability negotiation between UE 101 and communication network via 5GMM capability exchange. The figure also depicts signalling between core network and Next-Generation Radio Access Network (NG-RAN) 102a node. The communication network 102 comprises of NG-RAN 102a, Access and Mobility Function (AMF) 102b and Session Management Function (SMF) 102c.

In an embodiment, the UE 101 sends an uplink-message to the communication network 102 to register its intention of joining a multicast session identified by an MBS Session ID. This uplink-message may also contain the UE's 101 capability to join the multicast session in the RRC_INCATIVE state.

In an embodiment, the UE 101 includes an indication as part of 5GMM capability Information Element (IE) during registration procedure, indicating whether it supports receiving multicast service in Radio Resource Control_INACTIVE (RRC_INACTIVE) state. The IE is stored by AMF 102b in the UE-context and is further sent to NG-RAN 102a as part of an existing or a new NG-AP IE or UE_Context_Modification_Messsage as indicated as Option 2 in the FIG. 3. In another embodiment, the IE may be sent to SMF 102c as part of Nsmf_PDUSession_UpdateSMContext request message, when AMF 102b sends the join request to the SMF 102c. The SMF 102c can then provide the IE to the NG-RAN 102a as part of N2-SM information i.e. as part of the N2SM_Message as shown as Option 1 in the FIG. 3.

The UE's 101 capability is stored at the NG-RAN 102a. The multicast session activation may be triggered and at this point of time, UE 101 can start receiving multicast service. The NG-RAN 102a may send RRC Release with Suspend configuration to the UE 101 to move it to RRC_INACTIVE state. This could be triggered by, e.g., congestion at network, and/or UE 101 not utilizing non-multicast services.

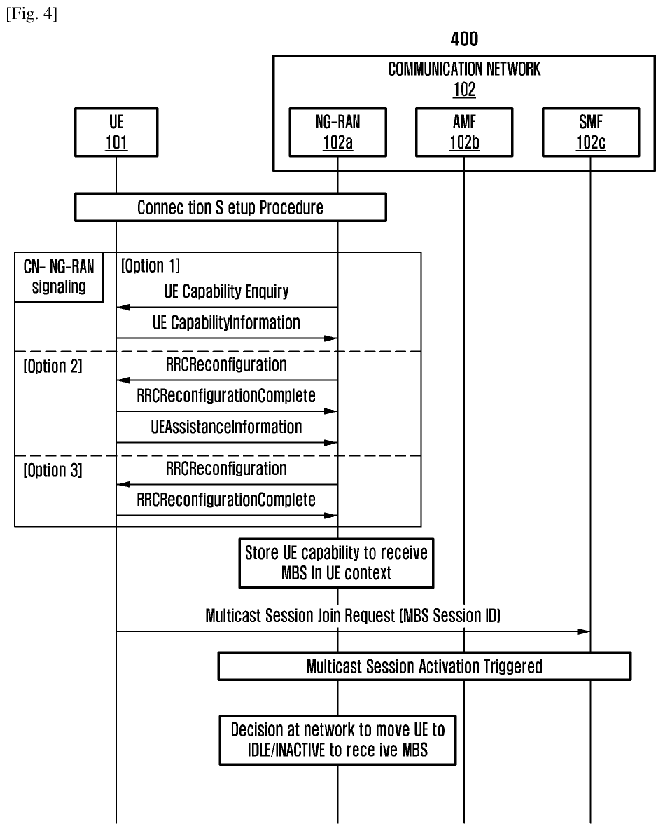

FIG. 4 shows the signalling of UE's support to receive Multicast Broadcast Service (MBS) in INACTIVE state and also other UE capability parameters at access stratum level message exchange between UE 101 and Next-Generation Radio Access Network (NG-RAN) 102a. It depicts a communication network 102 which comprises the NG-RAN 102a, Access and Mobility Function (AMF) 102b and Session Management Function (SMF) 102c.

In an embodiment, the UE 101 sends an uplink-message to the communication network 102 to register its intention of joining a multicast session identified by an MBS Session ID. This uplink-message may also contain the UE's 101 capability to join the multicast session in the Radio Resource Control_INACTIVE (RRC_INACTIVE) state.

In an embodiment, the UE 101 includes an indication as part of an RRC message. The RRC message could be at least one of UE capability information message, UE assistance information message, MBS interest indication message, RRC Connection Request, RRC Setup Request, RRC Setup Complete, RRC Reconfiguration Complete, RRC Reestablishment Request, RRC Reestablishment Complete, RRC Resume Request, RRC Resume Complete messages. The Information Element (IE) is stored by NG-RAN 102a in the UE-context and may further be sent to AMF 102b and/or SMF 102c for storing as part of their UE-Context data.

The multicast session activation may be triggered and at this point of time, UE 101 can start receiving multicast service. The NG-RAN 102a may send RRC Release with Suspend configuration to the UE 101 to move it to RRC_INACTIVE state. This could be triggered by, e.g., congestion at network, and/or UE 101 not utilizing non-multicast services.

The Table 1 below shows an example encoding of the capability in 5GMM Capability Information Element as defined in 3GPP TS 24.501. The parameter MBS-RRCIv may define the UE's ability of receiving multicast data in Radio Resource Control_INACTIVE (RRC_INACTIVE) state. Similar encoding can be implemented for 5GSM capability IE.

In an embodiment, the UE provides at least one of the following UE capability parameters and they can be represented by a bit, a bitmap, a field, a flag, an information element (IE) field or a message collectively or separately.nrmbs-Inactive-r18: This parameter indicates the UE capability to receive multicast in RRC_INACTIVE state. A UE supporting nrmbs-Inactive-r18 also supports multicast reception in RRC_CONNECTED state. However, at least in release 18 of NR MBS, a UE supporting nrmbs-Inactive-r18 does not imply support for multicast reception in RRC_IDLE state.

nrmbs-Inactive-pref-r18: This parameter indicates the UE preference to receive multicast in RRC_INACTIVE. The preference for receiving multicast in RRC_INACTIVE state could be over receiving multicast in RRC_CONNECTED state and/or receiving unicast in RRC_CONNECTED state.

nrmbs-Inactive-SCell-r18: This parameter indicates the UE capability to receive multicast on SCell in RRC_INACTIVE state. The BWP/CFR for multicast reception in RRC_INACTIVE on SCell can be the one used in RRC_CONNECTED state and/or Initial BWP. This may be a separate capability than that for receiving multicast in RRC_CONNECTED state on SCell.

nrmbs-Inactive-non-serving-r18: This parameter indicates the UE capability to receive multicast on non-serving cell in RRC_INACTIVE state. This may be a separate capability than that for receiving multicast in RRC_CONNECTED state on non-serving cell.

Supported BWPs/CFRs or band combination: This parameter indicates the supported BWPs/CFRs for multicast reception in RRC_INACTIVE state. This may include one or more dedicated unicast BWP and/or one or more MBS CFRs and/or initial BWP. Based on UE Rx/Tx capability, an UE can support one or more BWPs or CFRs or a band combination.

Intra-slot TDM for MBS PDSCH reception: This parameter indicates the support for intra-slot TDM for MBS (multicast and/or broadcast) PDSCH reception in RRC_INACTIVE state. This parameter may be same or different than the one reported for reception in RRC_CONNECTED state.

Inter-slot TDM for MBS PDSCH reception: This parameter indicates the support for inter-slot TDM for MBS (multicast and/or broadcast) PDSCH reception in RRC_INACTIVE state. This parameter may be same or different than the one reported for reception in RRC_CONNECTED state.

Number of simultaneous PDSCHs reception for MBS: This parameter indicates the support for a number of simultaneous PDSCHs reception for MBS (multicast and/or broadcast) PDSCH reception in RRC_INACTIVE state. This parameter may be same or different than the one reported for reception in RRC_CONNECTED state.

Number of simultaneous G-RNTIs/G-CS-RNTIs reception: This parameter indicates the support for a number of simultaneous G-RNTIs/G-CS-RNTIs reception for MBS (multicast and/or broadcast) PDSCH reception in RRC_INACTIVE state. This parameter may be same or different than the one reported for reception in RRC_CONNECTED state.

nrmbs-InactiveMeas-r18: This parameter indicates the support for measurements while MBS (multicast and/or broadcast) reception in RRC_INACTIVE state.

nrmbs-InactiveRelaxedMeas-r18: This parameter indicates the support for relaxed measurements while MBS (multicast and/or broadcast) reception in RRC_INACTIVE state.

nrmbs-InactiveMimo-r18: This parameter indicates the support for MIMO configuration while MBS (multicast and/or broadcast) reception in RRC_INACTIVE state. This parameter may be same or different than the one reported for reception in RRC_CONNECTED state.

nrmb-InactiveHarq-r18: This parameter indicates the support for MIMO configuration while MBS (multicast and/or broadcast) reception in RRC_INACTIVE state. This parameter may be same or different than the one reported for reception in RRC_CONNECTED state e.g. In RRC_INACTIVE state, it is possible that HARQ is not supported, only feedback less HARQ is supported (i.e. blind retransmission), SDT based HARQ feedback is supported etc.

nrmbs-Inactive-Slot-level repetition for group common PDSCH for multicast: This parameter indicates the support the Slot-level repetition for group common PDSCH for multicast in RRC_INACTIVE state.

In an embodiment, the UE provides the at least one of the UE capabilities or UE preferences or UE assistance in a message to the network dynamically about the reception of multicast in RRC_INACTIVE when the triggering conditions are fulfilled. The triggers may be configured by the network and may comprise of the events like meeting a threshold of the measured signal strength/quality meeting a threshold, link condition, battery power status, change in QoS requirement of multicast services and/or timers driven including the periodic timer, prohibit timer. The message can be a UE assistance information message.

The UE capable of providing multicast reception in RRC_INACTIVE related assistance/preference information in RRC_CONNECTED may initiate the procedure, upon detecting at least one of the configured triggering condition or upon having a preference for multicast reception in RRC_INACTIVE state.

In an embodiment, the network configures the UE to provide the assistance information comprising of one or combination of, capability of the UE to receive MBS in IDLE and/or INACTIVE state, preference to receive MBS in a specific RRC State i.e., CONNECTED/INACTIVE/IDLE. The network configures to UE to send the assistance information via the RRCReconfiguration message. A new IE is introduced to configure the UE to report the assistance information.

The Table 2 is an example depiction of the ASN structure for the new IE:

| RRCReconfiguration-vXYZ-IEs ::= | SEQUENCE { | |
|---|---|---|
| otherConfig-vXYZ | OtherConfig-vXYZ | OPTIONAL, |
| nonCriticalExtension | SEQUENCE [symbol] | OPTIONAL |

[symbol]

| OtherConfig-vXYZ ::= | SEQUENCE { | |
|---|---|---|
| mbsRxCapabilityReporting | ENUMERATED {true} | OPTIONAL, -- Need R |
| mbsPreferredRxState | ENUMERATED {true} | OPTIONAL, -- Need R |
| triggerCond | AssisatnceInfoTriggerCond | OPTIONAL, |

...

[symbol]

| AssistanceInfoTriggerCond::= | SEQUENCE { | |
|---|---|---|
| reportingType | CHOICE { | |
| periodicReporting | ReportInterval, | |
| triggerCond | CHOICE { | |
| linkQualityThreshold | LinkQualityThreshold | OPTIONAL, |
| qosBasedTrigger | ENUMERATED {true} | OPTIONAL, |
| powerStatusBasedTrigger | ENUMERATED {true} | OPTIONAL, |

```
    }
  },
}
LinkQualityThreshold::= SEQUENCE {
```

| | |
|---|---|
| threshold | Me [symbol] TriggerQuantity, |
| hyst [symbol] r [symbol] sis | Hyst [symbol] r [symbol] sis, |
| timeToTrigger | TimeToTrigger |

[symbol]

[symbol]

indicates data missing or illegible when filed

TABLE 2
OtherConfig-vXYZ field descriptions

mbsRxCapabilityReportingIndicates that the UE can report the capability
of the UE to receive MBS in INACTIVE/IDLE state.
mbsPreferredRxState Indicates that the UE can report a preference on
which state it wants to receive the MBS data in.
AssisatnceInfoTriggerCondConfigures the trigger condition to send the
assistance information. Upon meeting the trigger condition, the UE
initiates the transmission of UE assistance information. The UE can
be configured to report periodically with a interval
or upon meeting a specific condition. The condition can be
1) Measured signal quality.
2) Change in experienced QoS
3) change in power profile of UE like battery power status

A new UE assistance information IE is introduced to signal the capability to receive MBS in inactive state and/or the RRC state preference to receive MBS. An example ASN details for the new IEs is given in Table 3,

| UEAssistanceInformation-vXYZ-IEs | ::= SEQUENCE { | |
|---|---|---|
| idleInactiveMbsSupport | ENUMERATED {true} | OPTIONAL, |
| preferredMbsRxState | ENUMERATED {CONNECTED, IDLE, INACTIVE} | OPTIONAL, |
| nonCriticalExtensions | SEQUENCE { } | OPTIONAL |

[symbol]

[symbol]

indicates data missing or illegible when filed

TABLE 3
UEAssistanceInformation-vXYZ-IEs field descriptions

idleInactiveMbsSupport: Indicates that capability of the UE to receive
MBS multicast in INACTIVE state. If absent, the UE supports only
connected state multicast reception
preferredMbsRxState: Indicates that the UE's preference on which
state it wants to receive the MBS multicast in.

In an embodiment, the UE capable of indicating its ability to receive MBS in RRC IDLE/INACTIVE state may initiate the procedure, if it was configured to do so, including upon having a preference on MBS multicast reception in specific RRC state and upon change of its capability to receive MBS multicast in INACTIVE state due to factors such as multi-sim operation, change in power profile, measured signal strengths etc. Upon initiating the procedure, the UE shall:
1> if configured to provide multicast reception in RRC_INACTIVE related assistance/preference information:
2> if the UE did not transmit a UEAssistanceInformation message with “multicast reception in RRC_INACTIVE related assistance/preference information” since it was configured to provide the same; or
2> if the current “multicast reception in RRC_INACTIVE related assistance/preference information” is different from the one indicared in the last transmission of the UEAssistancelaformation message including “multicast reception in RRC_INACTIVE related assistance/preference information” and timer Txxx is not running; or
2> if there is detection for at least one of the configured triggering condition for “multicast reception in RRC_INACTIVE related assistance/preference information” and timer Txxx is not running: of
2> if there is a change in preference for multicast reception in RRC_INACTIVE and timer Txxx is not running:
   3> start or restart timer Txxx with the timer value set to the ProhibitTimer for “multicast reception in RRC_INACTIVE related assistance/preference information”;
   3> initiate transmission of the UEAssistanceInformation message to provide a “multicast reception in RRC_INACTIVE related assistance/preference information”;

With the indications outlined above, UEs will be able to receive multicast service in RRC_INACTIVE state, and network will have ability to inform the UEs if it intends to and/or enables delivery of all multicast services or specific multicast services in RRC_INACTIVE state. For the UEs that do not support receiving multicast service in RRC_INACTIVE state, network will not move those UEs to RRC_INACTIVE state even if multicast service is the only service being received by UEs in RRC_CONNECTED state.

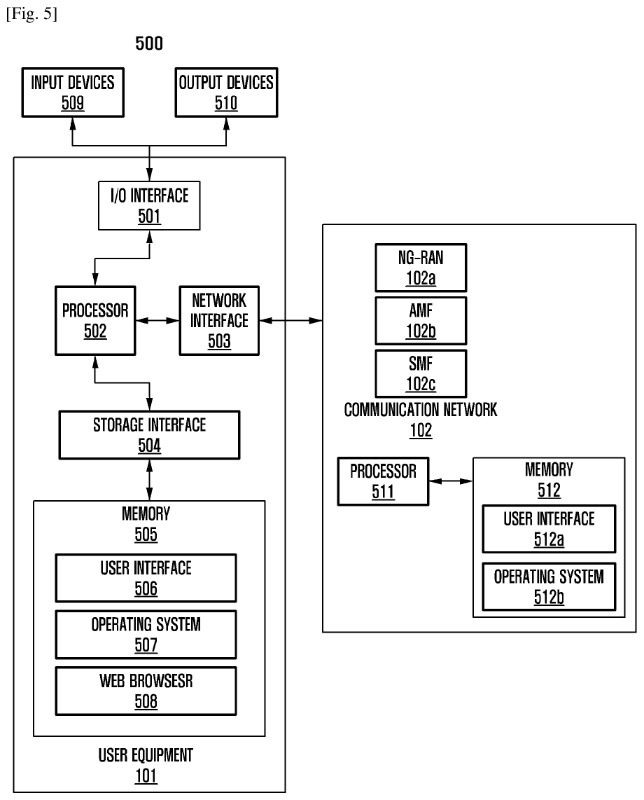

FIG. 5 illustrates a block diagram of an exemplary user equipment 101 for implementing embodiments consistent with the present disclosure. The UE 101 may include a central processing unit (“CPU” or “processor”) 502. The processor 502 may include at least one data processor for executing processes. The processor 502 may include specialized processing units such as, integrated system (bus) controllers, memory management control units, floating point units, graphics processing units, digital signal processing units, etc.

The processor 502 may be disposed in communication with one or more input/output (I/O) devices 509 and 510 via I/O interface 501. The I/O interface 501 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the UE 101 may communicate with one or more I/O devices 509 and 510. For example, the input devices 509 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 510 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processor 502 may be disposed in communication with the communication network 102 via a network interface 503. The network interface 503 may communicate with the communication network 102. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 102 may include, without limitation, a direct interconnection, local area network (LAN), wide area network (WAN), wireless network (e.g., using Wireless Application Protocol), the Internet, etc. Using the network interface 503 and the communication network 102, the UE 101 may communicate with plurality of network elements present within the communication network 102.

The communication network 102 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The communication network 102 may include, but is not limited to, network elements such as Next Generation Radio Access Network (NG-RAN) 102a, Access and Mobility Management Function (AMF) 102b, Session Management Function (SMF) 102c, and such. Further, the communication network may include a variety of network devices, including routers, bridges, servers, computing devices, storage devices, etc. The communication network comprises a processor 511 and a memory 512.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, UE 101 may store user/application data, such as, the data, variables, records, etc., as described in this disclosure. Such databases may be implemented as fault-tolerant, relational, scalable, secure databases such as Oracle® or Sybase®.

The operating system 507 may facilitate resource management and operation of the UE 101. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the processor 511 may be disposed in communication with a memory 512 (e.g., RAM, ROM, etc. not shown in FIG. 5). The memory 512 includes, but is not limited to memory drives, removable disc drives, etc., The memory drives may further include a drum, magnetic disc drive, magneto-optical drive, optical drive, Redundant Array of Independent Discs (RAID), solid-state memory devices, solid-state drives, etc.

The memory 512 may store a collection of program or database components, including, without limitation, user interface 512a, an operating system 512b etc. In some embodiments, UE 101 may store user/application data, such as, the data, variables, records, etc., as described in this disclosure. Such databases may be implemented as fault-tolerant, relational, scalable, secure databases such as Oracle® or Sybase®.

The operating system 512b may facilitate resource management and operation of the UE 101. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

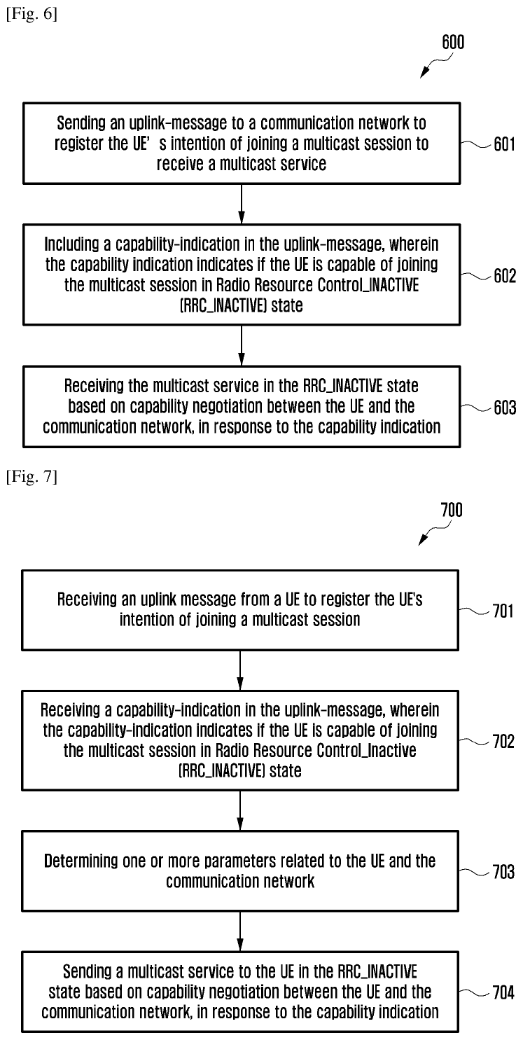

FIG. 6 depicts a flow diagram of an exemplary method 600 for assisting capability negotiation between a User Equipment (UE) and a communication network for multicast service delivery to the UE.

At step 601, the method may include sending an uplink-message to a communication network to register the UE's intention of joining a multicast session to receive a multicast service. At step 602, the method may include, including a capability-indication in the uplink-message, wherein the capability indication indicates if the UE is capable of joining the multicast session in Radio Resource Control_INACTIVE (RRC_INACTIVE) state. At step 603, the method may include, receiving the multicast service in the RRC_INACTIVE state based on capability negotiation between the UE and the communication network, in response to the capability indication.

FIG. 7 s a flow diagram of an exemplary method for assisting negotiation between a communication network and a User Equipment (UE) for multicast service delivery by the communication network.

At step 701, the method may include, receiving an uplink message from a UE to register the UE's intention of joining a multicast session. At step 702, the method may include, receiving a capability-indication in the uplink-message, wherein the capability-indication indicates if the UE is capable of joining the multicast session in Radio Resource Control_Inactive (RRC_INACTIVE) state. At step 703, the method may include, determining one or more parameters related to the UE and the communication network. At step 704, the method may include, sending a multicast service to the UE in the RRC_INACTIVE state based on capability negotiation between the UE and the communication network, in response to the capability indication.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMS, PROMs, RAMS, DRAMs, SRAMs, Flash Memory, firmware, programmable logic, etc.), etc. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), etc.).

An “article of manufacture” includes non-transitory computer readable medium, and/or hardware logic, in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 1-4, and 6-7 shows certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### Abbreviations

AMF Access and Mobility Management Function
SMF Session Management Function
UE User Equipment
3gpp 3rd Generation Partnership Project
PLMN Public Land Mobile Network
NAS Non-Access Stratum
NG-RAN Next Generation Radio Access Network
gNB Next Generation NodeB
IE Information Element
5MBS 5G Multicast Broadcast Service
TMGI Temporary Mobile Group Identity
SSM Source-specific IP Multicast Address
5GS 5G System
PDU-Session Protocol Data Unit Session
N1-SM N1 Session Management (container)
N2-SM N2 Session Management (container)
RRC Radio Resource Control

1-15. (canceled)

16. A method performed by a terminal in a wireless communication system, the method comprising:
transmitting, to a base station, a first message including first information indicating whether the terminal supports a multicast reception in a radio resource control (RRC) inactive state;
receiving, from the terminal, a second message including second information for the multicast reception in the RRC inactive state; and
receiving a multicast broadcast service (MBS) data in the RRC inactive state based on the first information and the second information.

17. The method of claim 16, wherein the first information is included in a user equipment (UE) capability information element.

18. The method of claim 16, wherein the second information is included information on suspend configuration included in an RRC release message.

19. The method of claim 16, further comprising:
receiving, from the base station, third information indicating whether the terminal supports receiving retransmission, in case that the MBS data is received in the RRC inactive state.

20. The method of claim 16, further comprising:
receiving, from the base station, at least one of fourth information indicating that the terminal supports an inter-slot TDM for receiving the MBS data in the RRC inactive state, fifth information indicating that the terminal support an intra-slot TDM for receiving the MBS data in the RRC inactive state, sixth information indicating that the terminal supports a slot-level repetition for receiving the MBS data in the RRC inactive state, or seventh information associated with a number of G-RNTIs for receiving the MBS data in the RRC inactive state,
wherein the seventh information is applicable in an RRC connected state.

21. A terminal in a wireless communication system, the terminal comprising:
a transceiver; and
at least one processor configured to:
transmit, to a base station via the transceiver, a first message including first information indicating whether the terminal supports a multicast reception in a radio resource control (RRC) inactive state,
receive, from the terminal via the transceiver, a second message including second information for the multicast reception in the RRC inactive state, and
receive, via the transceiver, a multicast broadcast service (MBS) data in the RRC inactive state based on the first information and the second information.

22. The terminal of claim 21, wherein the first information is included in a user equipment (UE) capability information element.

23. The terminal of claim 21, wherein the second information is included information on suspend configuration included in an RRC release message.

24. The terminal of claim 21, wherein the at least one processor is further configured to:
receive, from the base station via the transceiver, third information indicating whether the terminal supports receiving retransmission, in case that the MBS data is received in the RRC inactive state.

25. The terminal of claim 21, wherein the at least one processor is further configured to:
receive, from the base station via the transceiver, at least one of fourth information indicating that the terminal supports an inter-slot TDM for receiving the MBS data in the RRC inactive state, fifth information indicating that the terminal support an intra-slot TDM for receiving the MBS data in the RRC inactive state, sixth information indicating that the terminal supports a slot-level repetition for receiving the MBS data in the RRC inactive state, or seventh information associated with a number of G-RNTIs for receiving the MBS data in the RRC inactive state,
wherein the seventh information is applicable in an RRC connected state.

26. A method performed by a base station in a wireless communication system, the method comprising:
receiving, from a terminal, a first message including first information indicating whether the terminal supports a multicast reception in a radio resource control (RRC) inactive state;
transmitting, to the terminal, a second message including second information for the multicast reception in the RRC inactive state; and
transmitting, to the terminal in the RRC inactive state, a multicast broadcast service (MBS) data based on the first information and the second information.

27. The method of claim 26, wherein the first information is included in a user equipment (UE) capability information element.

28. The method of claim 26, wherein the second information is included information on suspend configuration included in an RRC release message.

29. The method of claim 26, further comprising:
transmitting, to the terminal, third information indicating whether the terminal supports receiving retransmission, in case that the MBS data is received in the RRC inactive state.

30. The method of claim 26, further comprising:
transmitting, to the terminal, at least one of fourth information indicating that the terminal supports an inter-slot TDM for receiving the MBS data in the RRC inactive state, fifth information indicating that the terminal support an intra-slot TDM for receiving the MBS data in the RRC inactive state, sixth information indicating that the terminal supports a slot-level repetition for receiving the MBS data in the RRC inactive state, or seventh information associated with a number of G-RNTIs for receiving the MBS data in the RRC inactive state,
wherein the seventh information is applicable in an RRC connected state.

31. A base station in a wireless communication system, the base station comprising:
a transceiver; and
at least one processor configured to:
receive, from a terminal via the transceiver, a first message including first information indicating whether the terminal supports a multicast reception in a radio resource control (RRC) inactive state,
transmit, to the terminal via the transceiver, a second message including second information for the multicast reception in the RRC inactive state, and
transmit, to the terminal in the RRC inactive state via the transceiver, a multicast broadcast service (MBS) data based on the first information and the second information.

32. The base station of claim 31, wherein the first information is included in a user equipment (UE) capability information element.

33. The base station of claim 31, wherein the second information is included information on suspend configuration included in an RRC release message.

34. The base station of claim 31, wherein the at least one processor is further configured to:
transmit, to the terminal via the transceiver, third information indicating whether the terminal supports receiving retransmission, in case that the MBS data is received in the RRC inactive state.

35. The base station of claim 31, wherein the at least one processor is further configured to:
transmit, to the terminal via the transceiver, at least one of fourth information indicating that the terminal supports an inter-slot TDM for receiving the MBS data in the RRC inactive state, fifth information indicating that the terminal support an intra-slot TDM for receiving the MBS data in the RRC inactive state, sixth information indicating that the terminal supports a slot-level repetition for receiving the MBS data in the RRC inactive state, or seventh information associated with a number of G-RNTIs for receiving the MBS data in the RRC inactive state,
wherein the seventh information is applicable in an RRC connected state.
